(19) United States
(12) Patent Application Publication
(10) Pub. No.: US 2011/0200571 A1
(43) Pub. Date: Aug. 18, 2011

(54) Methods for Reducing Nematode Damage to Plants

(76) Inventors: John W. Bell, Chapel Hill, NC (US); Kevin Adam, Cary, NC (US); John Hinz, Story City, IA (US); Jennifer Riggs, Raleigh, NC (US); Ray Knake, Johnston, IA (US)

(21) Appl. No.: 13/024,810

(22) Filed: Feb. 10, 2011

Related U.S. Application Data
(60) Provisional application No. 61/303,921, filed on Feb. 12, 2010.

(51) Int. Cl. A01N 63/02; A01N 43/50; A01N 43/38; A01P 5/00; A01P 3/00

(52) U.S. Cl. 424/93.46; 514/341; 514/409

(57) ABSTRACT

Methods and compositions for controlling nematode plant damage using seed and/or soil and foliar treatments are disclosed. Seeds, soil, or both are treated with a nematicidal composition followed later by a foliar treatment by a different nematicidal composition.

### CROSS REFERENCE TO RELATED APPLICATIONS

This application claims priority to U.S. Provisional Appl. No. 61/303,921, filed Feb. 12, 2010, the content of which is herein incorporated by reference in its entirety.

### FIELD

Methods for reducing overall damage and losses in plant health, vigor, and yield caused by plant parasitic nematodes are disclosed. More specifically, methods of treating plants to reduce nematode damage by applying a seed or soil treatment followed by a foliar treatment are described.

### BACKGROUND

Nematodes are microscopic unsegmented worms known to reside in virtually every type of environment (terrestrial, freshwater, marine). Of the over 80,000 known species, many are agriculturally significant, particularly those classified as pests. One such species is the root knot nematode which attacks a broad range of plants, shrubs, and crops. These soil-born nematodes attack newly formed roots causing stunted growth, swelling or gall formation. The roots may then crack open thus exposing the roots to other microorganisms such as bacteria and fungi. With environmentally friendly practices such as reduced or no tillage farming, and various nematode species acquiring resistance to transgenic seed, nematode related crop losses appear to be on the rise.

Chemical nematicides such as soil fumigants or non-fumigants have been in use for many years to combat infestations. Such nematicides may require repeated applications of synthetic chemicals to the ground prior to or at planting. Due to their toxicity, chemical nematicides have come under scrutiny from the Environmental Protection Agency (EPA) and in some cases their use has been limited or restricted by the EPA. As the use of traditional chemical nematicides such as methyl-bromide and organophosphates continue to be phased out, a need for the development of alternative treatment options has arisen.

Damage to plant and crop yields by nematodes occurs throughout the growing season. Current practices treat the seeds prior to planting or treat the soil around the plant. Nematicides are typically not applied at later growth stages, especially as a foliar application, mainly due to the limited availability of suitable nematicides, the ineffectiveness of available nematicides and due to the crop injury incurred from the effective but highly toxic nematicides. Instead, farmers have relied on a plant-based resistance approach to inhibition of nematodes. This involves cultivating and breeding naturally-occurring strains/variants of crops that are innately more resistant and tolerant to nematodes. This feature is then selectively bred into various seed genetic lines. While this has found some success, there is still significant crop loss due to nematode infestations during planting and growth stages. Unfortunately, nematode infestation is difficult to spot visually because the effects are not obvious. It has also been difficult to diagnose nematode infestation by loss of yield.

Therefore, there remains a need for effective methods to reduce nematode infestation throughout the growing cycle.

### SUMMARY

One aspect relates to a method for reducing nematode damage to a plant which comprises treatment of a seed prior to planting followed by treatment of the leaves of a plant obtained from the seed.

Another aspect relates to a method for reducing nematode damage to a plant which comprises treatment of soil surrounding a plant followed by treatment of the leaves of a plant.

Another aspect relates to a method for reducing plant damage to a plant which comprises treatment of a seed prior to planting, treatment of the soil surrounding a plant or both followed by treatment of a plant part of a plant produced from the seed.

### BRIEF DESCRIPTION OF THE FIGURES

FIG. 1 shows the effect of spirotetramat on Volkamer lemon seedlings infested with T. semipenetrans (a citrus nematode) 30 and 60 days after treatment.

FIG. 2 shows the reduction in damage from P. vulnus (a root lesion nematode) on mature walnut trees following a foliar spray application of spirotetramat.

FIG. 3 shows the yield (bushels per acre) of soybean infested with Soybean Cyst Nematode in an (A) untreated sample, (B) soybean foliage treated with ULTOR (Bayer CropScience), (C) soybean seed treated with Poncho®/VOTiVO (Bayer CropScience), and (D) soybean seed treated with Poncho/VOTiVO followed by foliage treatments with ULTOR.

FIG. 4 shows the yield (bushels per acre) of soybean infested with Cyst Nematode from two separate studies in an (A) untreated sample, (B) soybean seed treated with Trilex-Yield Shield (Bayer CropScience) and Poncho/VOTiVO, and (C) soybean seed treated with Trilex-Yield Shield Poncho/VOTiVO followed by foliage treatments with CMT 4586.

FIG. 5 shows the population of juvenile Southern Root-knot nematodes in 500 cc of soil at the time of planting and at the time of harvest for tomato in the (A) untreated sample, (B) a sample treated with a soil application of Vydate (DuPont) at planting and (C) a sample treated with a soil application of Vydate, followed by foliage treatments of Movento.

FIG. 6 shows the yield (total fruit weight per plant in Kg) of tomato infested with Southern Root-knot nematode in an (A) untreated sample, (B) a sample treated with a soil application of Vydate (DuPont) at planting and (C) a sample treated with a soil application of Vydate at planting followed by foliage treatments of Movento.

FIG. 7 shows the percent infection and culls in Potato infested with Columbia Root-knot nematode in an (A) untreated sample (B) potato foliage treated with Movento, (C) potato treated with soil treatment of Temik, followed by foliage treatments of Movento, and (C) potato treated with soil treatment of Temik.

FIG. 8 shows the population of juvenile Reniform nematodes in 500 cc of soil at the time of planting and at the time of harvest in cotton in a (A) base fungicidal seed treatment, (B) cotton seed treated with a base fungicide seed treatment and Poncho/VOTiVO (Bayer CropScience)/Aeris, and (C) cotton seed treated with a base fungicide seed treatment and Poncho/VOTiVO (Bayer CropScience)/Aeris followed by foliage treatments with CMT 4586.

### DETAILED DESCRIPTION

U.S. Provisional Application No. 61/191,620, the contents of which are incorporated in their entirely by reference describes products comprising genetically modified seed and at least one agriculturally beneficial spore forming bacterium combined with an optional insect control agent, and methods for utilizing the combination for treating seeds, plants, and plant parts.

Treatment of a seed may be achieved by exposing the seed to a composition comprising bacteria that have the ability to provide protection from the harmful effects of plant pathogenic fungi or bacteria and/or soil born animals such as those belonging to Nematoda or Aschelminthes. Protection against plant parasitic nematodes and parasitic microorganisms can occur through chitinolytic, proteolytic, collagenolytic, or other activities detrimental to these soil born animals and/or detrimental to microbial populations. Bacteria exhibiting these nematicidal, fungicidal and bactericidal properties may include but are not limited to, Bacillus argri, Bacillus aizawai, Bacillus albolactis, Bacillus amyloliquefaciens, Bacillus cereus, Bacillus coagulans, Bacillus endoparasiticus, Bacillus endorhythmos, Bacillus firmus, Bacillus kurstaki, Bacillus lacticola, Bacillus lactimorbus, Bacillus lactis, Bacillus laterosporus, Bacillus lentimorbus, Bacillus licheniformis, Bacillus megaterium, Bacillus medusa, Bacillus metiens, Bacillus natto, Bacillus nigrificans, Bacillus popillae, Bacillus pumilus, Bacillus siamensis, Bacillus sphearicus, Bacillus spp., Bacillus subtilis, Bacillus thurngiensis, Bacillus unifagellatus, plus those listed in the category of Bacillus Genus in Bergey's Manual of Systematic Bacteriology, First Ed. (1986), hereby incorporated by reference in its entirety.

In one embodiment, spore-forming bacteria or root colonizing bacteria are used to protect the seed. Examples of suitable bacteria include B. firmus CNCM I-1582 spore, B. cereus strain CNCM I-1562 spore both of which are disclosed in U.S. Pat. No. 6,406,690, the contents of which are incorporated in their entirety by reference. Other spore-forming bacteria include B. amyloliquefaciens IN937a, B. subtilis strain designated GB03, and B. pumulis strain designated GB34. Further, the spore-forming bacteria can be a mixture of any species listed above, as well as other spore-forming, root colonizing bacteria known to exhibit agriculturally beneficial properties.

Seed or soil treatment compositions can include one or more chemical compounds with nematicidal activity. These include antibiotic nematicides such as abamectin; carbamate nematicides such as benomyl, carbofuran, carbosulfan, and cleothocard; oxime carbamate nematicides such as alanycarb, aldicarb, aldoxycarb, oxamyl; organophosphorous nematicides such as diamidafos, fenamiphos, fosthietan, phosphamidon, cadusafos, chlorpyrifos, dichlofenthion, dimethoate, ethoprophos, fensulfothion, fosthiazate, heterophos, isamidofos, isazofos, methomyl, phorate, phosphocarb, terbufos, thiodicarb, thionazin, triazophos, imicyafos, and mecarphon. Other compounds with nematicidal activity include acetoprole, benclothiaz, chloropicrin, dazomet, DB CP, DCIP, 1,2-dichloropropane, 1,3-dichloropropene, furfural, iodomethane, metam, methyl bromide, methyl isothiocyanate, and xylenols.

Seed or soil treatment compositions can include one or more biological nematicide agents such as Myrothecium verrucaria, Burholderia cepacia, Bacillus chitonosporus and Paecilomyces lilacinus or nematicidal agents of plant or animal origin such as hairpin proteins, amino acid sequences or virus, viroid particles.

Seed or soil treatment compositions can further comprise an effective amount of at least one fungicide. Suitable fungicides include aldimorph, ampropylfos, ampropylfos potassium, andoprim, anilazine, azaconazole, azoxystrobin, benalaxyl, benodanil, benomyl, benzamacril, benzamacryl-isobutyl, bialaphos, binapacryl, biphenyl, bitertanol, blasticidin-S, boscalid, bromuconazole, bupirimate, buthiobate, calcium polysulphide, capsimycin, captafol, captan, carbendazim, carboxin, carvon, quinomethionate, chlobenthiazone, chlorfenazol, chloroneb, chloropicrin, chlorothalonil, chlozolinate, clozylacon, cufraneb, cymoxanil, cyproconazole, cyprodinil, cyprofuram, debacarb, dichlorophen, diclobutrazole, diclofluanid, diclomezine, dicloran, diethofencarb, difenoconazole, dimethirimol, dimethomorph, dimoxystrobin, diniconazole, diniconazole-M, dinocap, diphenylamine, dipyrithione, ditalimfos, dithianon, dodemorph, dodine, drazoxolon, edifenphos, epoxiconazole, etaconazole, ethirimol, etridiazole, famoxadon, fenapanil, fenarimol, fenbuconazole, fenfuram, fenitropan, fenpiclonil, fenpropidin, fenpropimorph, fentin acetate, fentin hydroxide, ferbam, ferimzone, fluazinam, fludioxonil, flumetover, fluoromide, fluquinconazole, flurprimidol, flusilazole, flusulfamide, flutolanil, flutriafol, folpet, fosetyl-aluminium, fosetyl-sodium, fthalide, fuberidazole, furalaxyl, furametpyr, furcarbonil, furconazole, furconazole-cis, furmecyclox, guazatine, hexachlorobenzene, hexaconazole, hymexazole, imazalil, imibenconazole, iminoctadine, iminoctadine albesilate, iminoctadine triacetate, iodocarb, ipconazole, iprobenfos (IBP), iprodione, irumamycin, isoprothiolane, isovaledione, kasugamycin, kresoxim-methyl, copper preparations, such as: copper hydroxide, copper naphthenate, copper oxychloride, copper sulphate, copper oxide, oxine-copper and Bordeaux mixture, mancopper, mancozeb, maneb, meferimzone, mepanipyrim, mepronil, metalaxyl, metconazole, methasulfocarb, methfuroxam, metiram, metomeclam, metsulfovax, mildiomycin, myclobutanil, myclozolin, nickel dimethyldithiocarbamate, nitrothal-isopropyl, nuarimol, ofurace, oxadixyl, oxamocarb, oxolinic acid, oxycarboxim, oxyfenthiin, paclobutrazole, pefurazoate, penconazole, pencycuron, phosdiphen, pimaricin, piperalin, polyoxin, polyoxorim, probenazole, prochloraz, procymidone, propamocarb, propanosine-sodium, propiconazole, propineb, prothiocinazole, pyraclostrobin, pyrazophos, pyrifenox, pyrimethanil, pyroquilon, pyroxyfur, quinconazole, quintozene (PCNB), sulphur and sulphur preparations, tebuconazole, tecloftalam, tecnazene, tetcyclasis, tetraconazole, thiabendazole, thicyofen, thifluzamide, thiophanate-methyl, thiram, tioxymid, tolclofos-methyl, tolylfluanid, triadimefon, triadimenol, triazbutil, triazoxide, trichlamide, tricyclazole, tridemorph, trifloxystrobin, triflumizole, triforine, triticonazole, uniconazole, validamycin A, vinclozolin, viniconazole, zarilamide, zineb, ziram and also Dagger G, OK-8705, OK-8801, α-(1,1-dimethylethyl)-β-(2-phenoxyethyl)-1H-1,2,4-triazole-1-ethanol, α-(2,4-dichlorophenyl)-β-fluoro-β-propyl-1H-1,2,4-triazole-1-ethanol, α-(2,4-dichlorophenyl)-β-methoxy-α-methyl-1H-1,2,4-triazole-1-ethanol, α-(5-methyl-1,3-dioxan-5-yl)-β-[[4-(trifluoromethyl)-phenyl]-methylene]-1H-1,2,4-triazole-1-ethanol, (5RS,6RS)-6-hydroxy-2,2,7,7-tetramethyl-5-(1H-1,2,4-triazol-1-yl)-3-octanone, (E)-α-(methoxyimino)-N-methyl-2-phenoxy-phenylacetamide, 1-isopropyl{2-methyl-1-[[[1-(4-methylphenyl)-ethyl]-amino]-carbonyl]-propyl}carbamate, 1-(2,4-dichlorophenyl)-2-(1H-1,2,4-triazol-1-yl)-ethanone-O-(phenylmethyl)-oxime, 1-(2-methyl-1-naphthalenyl)-1H-pyrrole-2,5-dione, 1-(3,5-dichlorophenyl)-3-(2-propenyl)-2,5-pyrrolidindione, 1-[(diiodomethyl)-sulphonyl]-4-methyl-benzene, 1-[[2-(2,4-dichlorophenyl)-1,3-dioxolan-2-yl]-methyl]-1H-imidazole, 1-[[2-(4-chlorophenyl)-3-phenyloxiranyl]-methyl]-1H-1,2,4-triazole, 1-[1-[2-[(2,4-dichlorophenyl)-methoxy]-phenyl]-ethenyl]-1H-imidazole, 1-methyl-5-nonyl-2-(phenylmethyl)-3-pyrrolidinole, 2′,6′-dibromo-2-methyl-4′-trifluoromethoxy-4′-trifluoro-methyl-1,3-thiazole-5-carboxanilide, 2,2-dichloro-N-[1-(4-chlorophenyl)-ethyl]-1-ethyl-3-methyl-cyclopropanecarboxamide, 2,6-dichloro-5-(methylthio)-4-pyrimidinyl-thiocyanate, 2,6-dichloro-N-(4-trifluoromethylbenzyl)-benzamide, 2,6-dichloro-N-[[4-(trifluoromethyl)-phenyl]-methyl]-benzamide, 2-(2,3,3-triiodo-2-propenyl)-2H-tetrazole, 2-[(1-methylethyl)-sulphonyl]-5-(trichloromethyl)-1,3,4-thiadiazole, 2-[[6-deoxy-4-O-(4-O-methyl-β-D-glycopyranosyl)-α-D-glucopyranosyl]-amino]-4-methoxy-1H-pyrrolo[2,3-d]pyrimidine-5-carbonitrile, 2-aminobutane, 2-bromo-2-(bromomethyl)-pentanedinitrile, 2-chloro-N-(2,3-dihydro-1,1,3-trimethyl-1H-inden-4-yl)-3-pyridinecarboxamide, 2-chloro-N-(2,6-dimethylphenyl)-N-(isothiocyanatomethyl)-acetamide, 2-phenylphenol (OPP), 3,4-dichloro-1-[4-(difluoromethoxy)-phenyl]-1H-pyrrole-2,5-dione, 3,5-dichloro-N-[cyano[(1-methyl-2-propynyl)-oxy]-methyl]-benzamide, 3-(1,1-dimethylpropyl-1-oxo-1H-indene-2-carbonitrile, 3-[2-(4-chlorophenyl)-5-ethoxy-3-isoxazolidinyl]-pyridine, 4-chloro-2-cyano-N,N-dimethyl-5-(4-methylphenyl)-1H-imidazole-1-sulphonamide, 4-methyl-tetrazolo[1,5-a]quinazolin-5(4H)-one, 8-(1,1-dimethylethyl)-N-ethyl-N-propyl-1,4-dioxaspiro[4,5]decane-2-methanamine, 8-hydroxyquinoline sulphate, 9H-xanthene-2-[(phenylamino)-carbonyl]-9-carboxylic hydrazide, bis-(1-methylethyl)-3-methyl-4-[(3-methylbenzoyl)-oxy]-2,5-thiophenedicarboxylate, cis-1-(4-chlorophenyl)-2-(1H-1,2,4-triazol-1-yl)-cycloheptanol, cis-4-[3-[4-(1,1-dimethylpropyl)-phenyl-2-methylpropyl]-2,6-dimethyl-morpholine hydrochloride, ethyl [(4-chlorophenyl)-azo]-cyanoacetate, potassium bicarbonate, methanetetrathiol-sodium salt, methyl 1-(2,3-dihydro-2,2-dimethyl-1H-inden-1-yl)-1H-imidazole-5-carboxylate, methyl N-(2,6-dimethylphenyl)-N-(5-isoxazolylcarbonyl)-DL-alaninate, methyl N-(chloroacetyl)-N-(2,6-dimethylphenyl)-DL-alaninate, N-(2,3-dichloro-4-hydroxyphenyl)-1-methyl-cyclohexanecarboxamide, N-(2,6-dimethylphenyl)-2-methoxy-N-(tetrahydro-2-oxo-3-furanyl)-acetamide, N-(2,6-dimethylphenyl)-2-methoxy-N-(tetrahydro-2-oxo-3-thienyl)-acetamide, N-(2-chloro-4-nitrophenyl)-4-methyl-3-nitro-benzenesulphonamide, N-(4-cyclohexylphenyl)-1,4,5,6-tetrahydro-2-pyrimidinamine, N-(4-hexylphenyl)-1,4,5,6-tetrahydro-2-pyrimidinamine, N-(5-chloro-2-methylphenyl)-2-methoxy-N-(2-oxo-3-oxazolidinyl)-acetamide, N-(6-methoxy)-3-pyridinyl)-cyclopropanecarboxamide, N-[2,2,2-trichloro-1-[(chloroacetyl)-amino]-ethyl]-benzamide, N-[3-chloro-4,5-bis(2-propinyloxy)-phenyl]-N′-methoxy-methanimidamide, N-formyl-N-hydroxy-DL-alanine-sodium salt, O,O-diethyl [2-(dipropylamino)-2-oxoethyl]-ethylphosphoramidothioate, O-methyl S-phenyl phenylpropylphosphoramidothioate, S-methyl 1,2,3-benzothiadiazole-7-carbothioate, spiro[2H]-1-benzopyrane-2,1′(3′H)-isobenzofuran]-3′-one, and Trilex-Yield Shield (Bayer CropScience) alone or in combination.

Seed or soil treatment compositions can further comprise an effective amount of at least one insecticide. Suitable insecticide include non-nematicidal, neonicotinoid insecticides such 1-(6-chloro-3-pyridylmethyl)-N-nitroimidazolidin-2-ylideneamine (imidacloprid), 3-(6-chloro-3-pyridylmethyl)-1,3-thiazolidin-2-ylidenecyanamide (thiacloprid), 1-(2-chloro-1,3-thiazol-5-ylmethyl)-3-methyl-2-nitroguanidine (clothianidin), nitempyran, N¹-[(6-chloro-3-pyridyl)methyl]-N²-cyano-N¹-methylacetamidine (acetamiprid), 3-(2-chloro-1,3-thiazol-5-ylmethyl)-5-methyl-1,3,5-oxadiazinan-4-ylidene(nitro)amine (thiamethoxam) and 1-methyl-2-nitro-3-(tetrahydro-3-furylmethyl)guanidine (dinotefuran).

Seed or soil treatment compositions can further comprise an effective amount of at least one herbicide. Suitable herbicides include: amide herbicides such as allidochlor, beflubutamid, benzadox, benzipram, bromobutide, cafenstrole, CDEA, chlorthiamid, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid and tebutam; anilide herbicides such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen and propanil; arylalanine herbicides such as benzoylprop, flampropand flamprop-M; chloroacetanilide herbicides such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor and xylachlor; sulfonanilide herbicides such as benzofluor, perfluidone, pyrimisulfan and profluazol; sulfonamide herbicides such as asulam, carbasulam, fenasulam and oryzalin; antibiotic herbicides such as bilanafos; benzoic acid herbicides such as chloramben, dicamba, 2,3,6-TBA and tricamba; pyrimidinyloxybenzoic acid herbicides such as bispyribac and pyriminobac; pyrimidinylthiobenzoic acid herbicides such as pyrithiobac; phthalic acid herbicides such as chlorthal; picolinic acid herbicides such as aminopyralid, clopyralid and picloram; quinolinecarboxylic acid herbicides such as quinclorac and quinmerac; arsenical herbicides such as cacodylic acid, CMA, DSMA, hexaflurate, MAA, MAMA, MSMA, potassium arsenite and sodium arsenite; benzoylcyclohexanedione herbicides such as mesotrione, sulcotrione, tefuryltrione and tembotrione; benzofuranyl alkylsulfonate herbicides such as benfuresate and ethofumesate; carbamate herbicides such as asulam, carboxazole chlorprocarb, dichlormate, fenasulam, karbutilate and terbucarb; carbanilate herbicides such as barban, BCPC, carbasulam, carbetamide, CEPC, chlorbufam, chlorpropham, CPPC, desmedipham, phenisopham, phenmedipham, phenmedipham-ethyl, propham and swep; cyclohexene oxime herbicides such as alloxydim, butroxydim, clethodim, cloproxydim, cycloxydim, profoxydim, sethoxydim, tepraloxydim and tralkoxydim; cyclopropylisoxazole herbicides such as isoxachlortole and isoxaflutole; dicarboximide herbicides such as benzfendizone, cinidon-ethyl, flumezin, flumiclorac, flumioxazin and flumipropyn; dinitroaniline herbicides such as benfluralin, butralin, dinitramine, ethalfluralin, fluchloralin, isopropalin, methalpropalin, nitralin, oryzalin, pendimethalin, prodiamine, profluralin and trifluralin; dinitrophenol herbicides such as dinofenate, dinoprop, dinosam, dinoseb, dinoterb, DNOC, etinofen and medinoterb; diphenyl ether herbicides such as ethoxyfen; nitrophenyl ether herbicides such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen and oxyfluorfen; dithiocarbamate herbicides such as dazomet and metam; halogenated aliphatic herbicides such as alorac, chloropon, dalapon, flupropanate, hexachloroacetone, iodomethane, methyl bromide, monochloroacetic acid, SMA and TCA; imidazolinone herbicides such as imazamethabenz, imazamox, imazapic, imazapyr, imazaquin and imazethapyr; inorganic herbicides such as ammonium sulfamate, borax, calcium chlorate, copper sulfate, ferrous sulfate, potassium azide, potassium cyanate, sodium azide, sodium chlorate and sulfuric acid; nitrile herbicides such as bromobonil, bromoxynil, chloroxynil, dichlobenil, iodobonil, ioxynil and pyraclonil; organophosphorus herbicides such as amiprofos-methyl, anilofos, bensulide, bilanafos, butamifos, 2,4-DEP, DMPA, EBEP, fosamine, glufosinate, glyphosate and piperophos; phenoxy herbicides such as bromofenoxim, clomeprop, 2,4-DEB, 2,4-DEP, difenopenten, disul, erbon, etnipromid, fenteracol and trifopsime; phenoxyacetic herbicides such as 4-CPA, 2,4-D, 3,4-DA, MCPA, MCPA-thioethyl and 2,4,5-T; phenoxybutyric herbicides such as 4-CPB, 2,4-DB, 3,4-DB, MCPB and 2,4,5-TB; phenoxypropionic herbicides such as cloprop, 4-CPP, dichlorprop, dichlorprop-P, 3,4-DP, fenoprop, mecopropand mecoprop-P; aryloxyphenoxypropionic herbicides such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P and trifop; phenylenediamine herbicides such as dinitramine and prodiamine; pyrazolyl herbicides such as benzofenap, pyrazolynate, pyrasulfotole, pyrazoxyfen, pyroxasulfone and topramezone; pyrazolylphenyl herbicides such as fluazolate and pyraflufen; pyridazine herbicides such as credazine, pyridafol and pyridate; pyridazinone herbicides such as brompyrazon, chloridazon, dimidazon, flufenpyr, metflurazon, norflurazon, oxapyrazon and pydanon; pyridine herbicides such as aminopyralid, cliodinate, clopyralid, dithiopyr, fluoroxypyr, haloxydine, picloram, picolinafen, pyriclor, thiazopyr and triclopyr; pyrimidinediamine herbicides such as iprymidam and tioclorim; quaternary ammonium herbicides such as cyperquat, diethamquat, difenzoquat, diquat, morfamquat and paraquat; thiocarbamate herbicides such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate and vernolate; thiocarbonate herbicides such as dimexano, EXD and proxan; thiourea herbicides such as methiuron; triazine herbicides such as dipropetryn, triaziflam and trihydroxytriazine; chlorotriazine herbicides such as atrazine, chlorazine, cyanazine, cyprazine, eglinazine, ipazine, mesoprazine, procyazine, proglinazine, propazine, sebuthylazine, simazine, terbuthylazine and trietazine; methoxytriazine herbicides such as atraton, methometon, prometon, secbumeton, simeton and terbumeton; methylthiotriazine herbicides such as ametryn, aziprotryne, cyanatryn, desmetryn, dimethametryn, methoprotryne, prometryn, simetryn and terbutryn; triazinone herbicides such as ametridione, amibuzin, hexazinone, isomethiozin, metamitron and metribuzin; triazole herbicides such as amitrole, cafenstrole, epronaz and flupoxam; triazolone herbicides such as amicarbazone, bencarbazone, carfentrazone, flucarbazone, propoxycarbazone, sulfentrazone and thiencarbazone-methyl; triazolopyrimidine herbicides such as cloransulam, diclosulam, florasulam, flumetsulam, metosulam, penoxsulam and pyroxsulam; uracil herbicides such as butafenacil, bromacil, flupropacil, isocil, lenacil and terbacil; 3-phenyluracils; urea herbicides such as benzthiazuron, cumyluron, cycluron, dichloralurea, diflufenzopyr, isonoruron, isouron, methabenzthiazuron, monisouron, noruron and saflufenacil; phenylurea herbicides such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluoron, phenobenzuron, siduron, tetrafluoron and thidiazuron; pyrimidinylsulfonylurea herbicides such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron and trifloxysulfuron; triazinylsulfonylurea herbicides such as chlorsulfuron, cinosulfuron, ethametsulfuron, iodosulfuron, metsulfuron, prosulfuron, thifensulfuron, triasulfuron, tribenuron, triflusulfuron and tritosulfuron; thiadiazolylurea herbicides such as buthiuron, ethidimuron, tebuthiuron, thiazafluoron and thidiazuron; and unclassified herbicides such as acrolein, allyl alcohol, aminocyclopyrachlor, azafenidin, benazolin, bentazone, benzobicyclon, buthidazole, calcium cyanamide, cambendichlor, chlorfenac, chlorfenprop, chlorflurazole, chlorflurenol, cinmethylin, clomazone, CPMF, cresol, ortho-dichlorobenzene, dimepiperate, endothal, fluoromidine, fluridone, fluorochloridone, flurtamone, fluthiacet, indanofan, indaziflam, methazole, methyl isothiocyanate, nipyraclofen, OCH, oxadiargyl, oxadiazon, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan and tritac. The seed or soil treatment compositions can also be used in conjunction with glyphosate, glufosinate or 2,4-D on glyphosate-tolerant, glufosinate-tolerant or 2,4-D-tolerant crops.

The seed or soil treatment compositions can also be used in combination with herbicide safeners, such as benoxacor, benthiocarb, brassinolide, cloquintocet (mexyl), cyometrinil, cyprosulfamide, daimuron, dichlormid, dicyclonon, dimepiperate, disulfoton, fenchlorazole-ethyl, fenclorim, flurazole, fluxofenim, furilazole, isoxadifen-ethyl, mefenpyr-diethyl, MG 191, MON 4660, naphthalic anhydride (NA), oxabetrinil, R29148 and N-phenyl-sulfonylbenzoic acid amides, to enhance their selectivity. The compositions can additionally be employed to control undesirable vegetation in many crops that have been made tolerant to, or resistant to, these or other herbicides by genetic manipulation or by mutation and selection. For example, corn, wheat, rice, soybean, sugarbeet, cotton, canola, and other crops that have been made tolerant or resistant to compounds that are acetolactate synthase inhibitors in sensitive plants can be treated. Many glyphosate and glufosinate tolerant crops can be treated as well, alone or in combination with these herbicides. Examples of tolerant crops include ROUNDUP READY, ROUNDUP READY 2 YIELD, ROUNDUP READY FLEX, LIBERTY LINK, CLEARFIELD hybrids and varieties, STS soybeans, POAST tolerant corn, OPTIMUM GAT corn and soybeans, DHT corn, soybeans and cotton. Other crops that can be treated include dicamba-resistance soybeans and cotton, 2,4-D resistant soybeans, ACCase-resistant grain sorghum and corn, ALS-resistant grain sorghum.

Along with the physical combination of these components while treating plants and plant parts, the seed or soil treatment compositions may be formulated to provide a stable environment for living spore-forming bacteriums such as spore-forming, root-colonizing bacteria. Various additives, such as fungicides, insecticides, stabilizers, emulsifiers, may be added to the spore-forming bacterium and/or genetically modified seed, plant, or plant part depending on the desired properties. Additives such as carboxymethylcellulose and natural and synthetic polymers in the form of powders, granules, or latexes, such as gum Arabic, chitin, polyvinyl alcohol and polyvinyl acetate, as well as natural phospholipids, such as cephalins and lecithins, and synthetic phospholipids, can be added to the composition.

Binders can be added to the seed or soil treatment compositions and include those composed of an adhesive polymer that can be natural or synthetic without phytotoxic effect on the seed to be coated. A variety of colorants may be employed, including organic chromophores classified as nitroso, nitro, azo, including monoazo, bisazo, and polyazo, diphenylmethane, triarylmethane, xanthene, methane, acridine, thiazole, thiazine, indamine, indophenol, azine, oxazine, anthraquinone, and phthalocyanine. Other additives that can be added include trace nutrients such as salts of iron, manganese, boron, copper, cobalt, molybdenum, and zinc. A polymer or other dust control agent can be applied to retain the treatment on the seed surface.

Other conventional seed treatment additives include, but are not limited to, coating agents, wetting agents, buffering agents, and polysaccharides. At least one agriculturally acceptable carrier can be added to the seed treatment formulation such as water, solids or dry powders. The dry powders can be derived from a variety of materials such as wood barks, calcium carbonate, gypsum, vermiculite, talc, humus, activated charcoal, and various phosphorous compounds.

Optionally, stabilizers and buffers can be added, including alkaline and alkaline earth metal salts and organic acids, such as citric acid and ascorbic acid, inorganic acids, such as hydrochloric acid or sulfuring acid. Biocides can also be added and can included formaldehydes or formaldehyde-releasing agents and derivatives of benzoic acid, such as p-hydroxybenzoic acid. Further additives include functional agents capable of protecting seeds from harmful effects of selective herbicides such as activated carbon, nutrients (fertilizers), and other agents capable of improving the germination and quality of the products or a combination thereof.

Components of the seed or soil treatment compositions can be converted into the customary formulations, such as solutions, emulsions, wettable powders, suspensions, powders, dusts, pastes, soluble powders, granules, suspoemulsion concentrates, natural and synthetic materials impregnated with active compound, and ultrafine encapsulations in polymeric materials. These formulations are produced in the known manner, for example by mixing the active compound with extenders, that is, liquid solvents and/or solid carriers, optionally with the use of surfactants, that is, emulsifiers and/or dispersants and/or foam formers. Suitable extenders are, for example, water, polar and unpolar organic chemical liquids, for example from the classes of the aromatic and nonaromatic hydrocarbons (such as paraffins, alkylbenzenes, alkylnaphthalenes, chlorobenzenes), of the alcohols and polyols (which can optionally also be substituted, etherified and/or esterified), of the ketones (such as acetone, cyclohexanone), esters (including fats and oils) and (poly)ethers, of the unsubstituted and substituted amines, amides, lactams (such as N-alkylpyrrolidones) and lactones, the sulphones and sulphoxides (such as dimethyl sulphoxide).

In the case of the use of water as an extender, organic solvents can, for example, also be used as cosolvents. Liquid solvents which are suitable are mainly: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, mineral oils and vegetable oils, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, and water.

Solid carriers which are suitable are for example, ammonium salts and ground natural minerals, such as kaolins, clays, talc, chalk, quartz, attapulgite, montmorillonite or diatomaceous earth, and ground synthetic minerals, such as highly-disperse silica, alumina and silicates; suitable solid carriers for granules are: for example crushed and fractionated natural rocks such as calcite, marble, pumice, sepiolite and dolomite, and synthetic granules of inorganic and organic meals, and granules of organic material such as sawdust, coconut shells, maize cobs and tobacco stalks; suitable emulsifiers and/or foam formers are: for example non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates as well as protein hydrolysates; suitable dispersants are: for example lignin-sulphite waste liquors and methylcellulose.

Adhesives such as carboxymethylcellulose and natural and synthetic polymers in the form of powders, granules or latices, such as gum arabic, polyvinyl alcohol and polyvinyl acetate, and natural phospholipids, such as cephalins and lecithins, and synthetic phospholipids, can be used in the formulations. Other additives can be mineral and vegetable oils. Colorants may be added such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

If the seed or soil treatment composition comprising bacteria and the chemical compounds with nematicidal activity, biological nematicide agents, fungicide, insecticides, stabilizers, and other additives are in powder form, they may be applied directly to the seed separately or mixed together and then applied to the seed. If the components are in liquid form, they may be sprayed or atomized onto the seed or in-furrow at the time of planting, either separately or mixed together.

The seeds are substantially uniformly coated with one or more layers of the composition comprising the bacteria and one or more optional compounds using conventional methods of mixing, spraying or a combination thereof. Application is generally done using specifically designed and manufactured equipment that accurately, safely, and efficiently applies seed treatment products to seeds. Such equipment uses various types of coating technology such as rotary coaters, drum coaters, fluidized bed techniques, spouted beds, rotary mists or a combination thereof. In one embodiment, application is done via either a spinning “atomizer” disk or a spray nozzle which evenly distributes the seed treatment onto the seed as it moves through the spray pattern. The seed may then be mixed or tumbled for an additional period of time to achieve additional treatment distribution and drying. The seeds can be primed or unprimed before coating with the inventive compositions to increase the uniformity of germination and emergence. In an alternative embodiment, a dry powder composition can be metered onto the moving seed.

The seeds may be coated via a continuous or batch coating process. In a continuous coating process, continuous flow equipment simultaneously meters both the seed flow and the seed treatment products. A slide gate, cone and orifice, seed wheel, or weight device (belt or diverter) regulates seed flow. Once the seed flow rate through treating equipment is determined, the flow rate of the seed treatment is calibrated to the seed flow rate in order to deliver the desired dose to the seed as it flows through the seed treating equipment. Additionally, a computer system may monitor the seed input to the coating machine, thereby maintaining a constant flow of the appropriate amount of seed. In a batch coating process, batch treating equipment weighs out a prescribed amount of seed and places the seed into a closed treating chamber or bowl where the corresponding of seed treatment is then applied. The seed and seed treatment are then mixed to achieve a substantially uniform coating on each seed. This batch is then dumped out of the treating chamber in preparation for the treatment of the next batch. With computer control systems, this batch process is automated enabling it to continuously repeat the batch treating process. In either coating process, the seed coating machinery can optionally be operated by a programmable logic controller that allows various equipment to be started and stopped without employee intervention. The components of this system are commercially available through several sources such as Gustafson Equipment of Shakopee, Minn.

In one embodiment, the seed or soil treatment composition along with one or more optional components are formulated as a soil treatment. The soil treatment may be in addition to, or as a substitute for, the seed treatment. Soil may be treated by application of the desired composition to the soil by conventional methods such as spraying. Alternatively, the desired composition can be introduced to the soil before germination of the seed or directly to the soil in contact with the roots by utilizing a variety of techniques included, but not limited to, drip irrigation, sprinklers, soil injection or soil drenching. The desired composition may be applied to the soil before planting, at the time of planting, or after planting.

In an aspect, after treatment of the soil, or seed, or both, plant, plant parts, or plant organs are subject to a foliar treatment. In an aspect, a plant part such as a shoot, leaf, flower, root, needle, stalk, stem, fruit bodies, seed, roots, or tuber are subject to a foliar treatment. In another aspect, the composition for foliar treatment comprises a systemic nematicidal agent. In yet another aspect, foliar-applied systemic nematicidal agents are compounds that can be applied to the foliage of affected plants and show no adverse plant compatibility properties. Following application, these foliar-applied nematicidal agents are absorbed into the leaf tissues where they move to the plant vascular system, specifically the phloem, and are systemically translocated to the root system. Examples of foliar-applied systemic nematicidal agents include, but not limited to, spirotetramat, oxamyl carbamate, fenamiphos, and MON37400 nematicide.

Spirotetramat, a tetramic acid derivative (ketoenol), is a known insecticide whose mode of action is inhibition of lipogenesis in treated insects, resulting in decreased lipid contents, growth inhibition of younger insects, and reduced ability of adult insects to reproduce. In contrast to standard insecticides, spirotetramat is actually taken up by the plant. It is then carried around the plant, including into roots and newly-forming shoots. Insect pests ingest the compound which then works by inhibiting lipid biosysnthesis, affecting reproduction in adults and especially juveniles. PCT/US2008/013829, the contents of which are incorporated in their entirety, discloses use of tetramic acid derivatives including but not limited to spirotetramat to reduce the population density of soil-dwelling plant-damaging nematodes in annual and perennial crops after foliar treatment.

In one embodiment, the foliar treatment composition further comprises additional agents with nematicidal activity. These additional agents include chemical compounds with nematicidal activity, biological agents with nematicidal activity, insecticides, and fungicides. In addition, the foliar treatment composition can also comprise the additives, binders, colorants, etc. previously described for seed treatment.

The nematodes susceptible to methods and compositions described include Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp., Belonolaimus longicaudatus, Mesocriconema xenoplax, Tylenchorhynchus spp., Rotylenchulus spp., Helicotylenchus multicinctus, Paratrichodorus spp., Paratylenchus spp., Criconemella spp., Hoplolaimus spp., Scutellonema spp., and Dolichodorus spp.

In an aspect, the methods and compositions disclosed herein reduce damage caused by nematodes by about 40% to about 50% compared to an untreated plant, crop, fruit, or vegetable. In another aspect, the methods and compositions disclosed herein reduce damage caused by nematodes by about 10% to about 20%, about 10% to about 30%, about 10% to about 40%, about 10% to about 90%, about 20% to about 80%, about 30% to about 70%, about 40% to about 60%, or about 5% or more, about 10% or more, about 20% or more, about 30% or more, about 40% or more, about 50% or more, about 60% or more, about 70% or more, about 80% or more, or about 90% or more, about 5% or less, about 10% or less, about 20% or less, about 30% or less, about 40% or less, about 50% or less, about 60% or less, about 70% or less, about 80% or less, or about 90% or less compared to an untreated plant, crop, fruit, or vegetable. In yet another aspect, the methods and compositions disclosed herein reduce damage caused by nematodes by about 5%, about 10%, about 20%, about 30%, about 40%, about 50%, about 60% about 70%, about 80%, or about 90% compared to an untreated plant, crop, fruit, or vegetable. In an aspect, the reduction percent is relative to a plant, crop, fruit, or seed treated with only a seed, soil, or combination seed or soil application. In another aspect, the reduction percent is relative to a plant, crop, fruit, or vegetable treated with only a foliar application. In an aspect, the nematode may be any of the disclosed nematodes, such as Soybean Cyst Nematode, Southern Root-knot Nematode, Columbia Root-knot Nematode, or Reniform Nematode.

In another aspect, the above reduction percent in nematode damage is calculated by comparing the following methodology (a) and (b):

(a) a method of evaluating nematode damage to a plant by sequentially first applying a compound or composition described herein to the soil, seed, or combination thereof of a plant, crop, fruit, or vegetable and second applying a compound or composition described herein to in a foliar application to a plant, crop, fruit, or vegetable; and

comparing the percent of nematode damage to

(b) a method of evaluating nematode damage to a plant by applying a compound or composition described herein to only one of a soil, seed, or foliar application.

In another aspect, methodology (a) is compared to a method of applying a compound or composition described herein to a combination of soil and seed.

In an aspect, the methods and compositions described herein increase crop yield by about 10% to about 20%, about 10%, about 30%, about 10% to about 40%, about 10% to about 90%, about 20% to about 80%, about 30% to about 70%, about 40% to about 60%, or about 5% or more, about 10% or more, about 20% or more, about 30% or more, about 40% or more, about 50% or more, about 60% or more, about 70% or more, about 80% or more, or about 90% or more compared to an untreated plant, crop, fruit, or vegetable. In yet another aspect, the methods and compositions described herein increase crop yield by about 5%, about 10%, about 20%, about 30%, about 40%, about 50%, about 60% about 70%, about 80%, or about 90% compared to an untreated plant, crop, fruit, or vegetable. In an aspect, the nematode may be any of the disclosed nematodes, Soybean Cyst Nematode, Southern Root-knot Nematode, Columbia Root-knot Nematode, or Reniform Nematode. In another aspect, the increased percent crop yield (for example, bushels per acre) is relative to a plant, crop, fruit, or vegetable treated with only a seed, soil, or combination seed or soil application.

In yet another aspect, the increased crop yield is calculated by comparing the following methodology (a) and (b):

(a) a method of analyzing crop yield by sequentially first applying a compound or composition described herein to the soil, seed, or combination thereof of a plant, crop, fruit, or vegetable and second applying a compound or composition described herein to in a foliar application to a plant, crop, fruit, or vegetable; and

comparing the crop yield percent to

(b) a method of analyzing crop yield by applying a compound or composition described herein to only one of a soil, seed, or foliar application.

In another aspect, methodology (a) is compared to a method of applying a compound or composition described herein to a combination of soil and seed.

In an aspect, a compound or composition described herein is sequentially applied to soil and the foliar region of a plant, but not to seed. In an aspect, a compound or composition described herein is sequentially applied to seed and the foliar region of a plant, but not to soil.

In an aspect, a compound or composition described herein is applied at about 0.01 pounds/acre to about 1 pounds/acre, about 0.01 pounds/acre to about 0.5 pounds/acre, about 0.01 pounds/acre to about 0.3 pounds/acre, about 0.01 pounds/acre to about 0.1 pounds/acre, or about 0.01 pounds/acre to about 0.05 pounds/acre. In another aspect, a compound or composition described herein is applied at about 0.001, about 0.01, about 0.1, about 0.2, about 0.3, about 0.4, about 0.47, about 0.5, about 0.6, about 0.7, about 0.74, about 0.8, about 0.9, or about 1.0 pounds/acre. In yet another aspect, a compound or composition described herein is applied at about 0.001 or more, about 0.01 or more, about 0.1 or more, about 0.2 or more, about 0.3 or more, about 0.4 or more, about 0.47 or more, about 0.5 or more, about 0.6 or more, about 0.7 or more, about 0.74 or more, about 0.8 or more, about 0.9 or more, or about 1.0 or more pounds/acre. In another aspect, a compound or composition described herein is applied at about 0.001 or less, about 0.01 or less, about 0.1 or less, about 0.2 or less, about 0.3 or less, about 0.4 or less, about 0.47 or less, about 0.5 or less, about 0.6 or less, about 0.7 or less, about 0.74 or less, about 0.8 or less, about 0.9 or less, or about 1.0 or less pounds/acre.

All plants and plant parts can be treated in accordance with the invention. In this context, plants are understood as meaning all plants and plant populations such as desired and undesired wild plants or crop plants (including naturally occurring crop plants). Crop plants can be plants which can be obtained by traditional breeding and optimization methods or by biotechnological and recombinant methods, or combinations of these methods, including the transgenic plants and including the plant varieties which are capable or not capable of being protected by Plant Breeders' Rights. Plant parts are understood as meaning all aerial and subterranean parts and organs of the plants such as shoot, leaf, flower and root, examples which may be mentioned being leaves, needles, stalks, stems, flowers, fruit bodies, fruits and seeds, but also roots, tubers and rhizomes. The plant parts also include crop material and vegetative and generative propagation material, for example cuttings, tubers, rhizomes, slips and seeds.

In one embodiment, plant species and plant varieties which are found in the wild or which are obtained by traditional biological breeding methods, such as hybridization or protoplast fusion, and parts of these species and varieties are treated. In a further preferred embodiment, transgenic plants and plant varieties which were obtained by recombinant methods, if appropriate in combination with traditional methods (genetically modified organisms) and their parts are treated. The terms “parts”, “parts of plants” or “plant parts” are described above.

Plants which can be treated include those of the varieties which are commercially available or in use. Plant varieties are understood as meaning plants with novel traits which have been bred both by conventional breeding, by mutagenesis or by recombinant DNA techniques. They may take the form of varieties, biotypes or genotypes. The transgenic plants or plant varieties (plants or plant varieties obtained by means of genetic engineering) which can be treated include all plants which, by means of the recombinant modification, have received genetic material which confers particularly advantageous valuable traits to these plants. Examples of such traits are better plant growth, increased tolerance to high or low temperatures, increased tolerance to drought or to water or soil salinity, increased flowering performance, facilitated harvest, speedier maturation, higher yields, higher quality and/or higher nutritional value of the crop products, better storability and/or processibility of the crop products. Other examples of such traits which are particularly emphasized are an improved defense of the plants against animal and microbial pests such as insects, mites, phytopathogenic fungi, bacteria and/or viruses, and an increased tolerance of the plants to specific herbicidal active compounds. Examples of transgenic plants which are mentioned are the important crop plants such as cereals (wheat, rice), maize, soybean, potato, cotton, tobacco, oilseed rape and fruit plants (with the fruits apples, pears, citrus fruits and grapes), with particular emphasis on maize, soybean, potatoes, cotton, tobacco and oilseed rape.

In an another aspect, crops and plants capable of being used in the disclosed methods include pomme fruit, stone fruit, grapevine, tea, almonds, nuts, coffee, tropical fruit, soft fruit, ornamental plants, lawn, olives, melons, beet, sugar beet, cereal, oranges, clementines, satsumas, lemons, grapefruits, cumquats, mandarines, apples, pears, peaches, nectarines, cherries, apricots, tea, mangoes, papayas, figs, pineapples, dates, bananas, durians, passion fruit, kakis, coconuts, cacao, coffee, avocados, lychees, maracuj as, guavas, sugar cane, hazelnuts, treenuts walnuts, pistachios, cashew nuts, brazil nuts, pecan nuts, butter nuts, chestnuts, hickory nuts, macadamia nuts, peanuts, blackcurrants, gooseberries, raspberries, blackberries, blueberries, strawberries, red bilberries, kiwis, cranberries, roses, carnations, gerbera, lilies, marguerites, chrysanthemums, tulips, daffodils, anemones, poppies, amaryllis, dahlias, azaleas, malves, gardenias, euphobias, bushes, conifers, fig trees, rhododendron, spruce trees, fir trees, pine trees, yew trees, juniper trees, golf lawn, garden lawn, bell peppers, chillies, tomatoes, aubergines, cucumbers, pumpkins, courgettes, broad beans, climbing and dwarf beans, peas, artichokes, lettuce, chicory, endives, various types of cress, of rocket, lamb's lettuce, iceberg lettuce, leeks, spinach, Swiss chard, celeriac/celery, beetroot, carrots, radish, horseradish, scorzonera, asparagus, beet for human consumption, palm hearts, bamboo shoots, furthermore bulb vegetables, onions, leeks, Florence fennel, garlic, Brassica vegetables such as cauliflower, broccoli, kohlrabi, red cabbage, white cabbage, curly kale, Savoy cabbage, Brussels sprouts, and Chinese cabbage.

Traits which are particularly emphasized are the increased defense of the plants against insects, arachnids, nematodes and slugs and snails as the result of toxins formed in the plants, in particular toxins which are produced in the plants by the genetic material of Bacillus thuringiensis (for example by the genes CryIA(a), CryIA(b), CryIA(c), CryIIA, CryIIIA, CryIIIB2, Cry9c, Cry2Ab, Cry3Bb and CryIF and their combinations) (herein below “Bt plants”). Traits which are also particularly emphasized are the increased defence of plants against fungi, bacteria and viruses by systemic acquired resistance (SAR), systemin, phytoalexins, elicitors and resistance genes and correspondingly expressed proteins and toxins. Traits which are furthermore especially emphasized are the increased tolerance of the plants to specific herbicidal active compounds, for example imidazolinones, sulphonylureas, glyphosate or phosphinothricin (for example “PAT” gene). The specific genes which confer the desired traits can also occur in combinations with one another in the transgenic plants.

Examples of “Bt plants” include maize varieties, cotton varieties, soybean varieties and potato varieties sold under the trade names YIELD GARD (for example maize, cotton, soybean), KNOCKOUT (for example maize), STARLINK (for example maize), BOLLGARD (cotton), NUCOTN (cotton) and NEWLEAF (potato). Examples of herbicide-tolerant plants which may be mentioned are maize varieties, cotton varieties and soybean varieties which are sold under the trade names ROUNDUP READY (glyphosate tolerance, for example maize, cotton, soybean), LIBERTY LINK (phosphinothricin tolerance, for example oilseed rape), IMI (imidazolinone tolerance) and STS (sulphonylurea tolerance, for example maize). Herbicide-resistant plants (bred conventionally for herbicide tolerance) which may also be mentioned are the varieties sold under the name CLEARFIELD (for example maize) Naturally, what has been said also applies to plant varieties which will be developed, or marketed, in the future and which have these genetic traits or traits to be developed in the future.

The plants and their parts may be treated with the described compositions by applying the compositions directly to the plants or plant parts. In another embodiment, the plant and plant parts may be treated indirectly, for example by treating the environment or habitat in which the plant parts are or are exposed to. Conventional treatment methods may be used to treat the environment or habitat including dipping, spraying, fumigating, fogging, scattering, brushing on, injecting, and, in the case of propagation material, in particular seeds, furthermore by coating with one or more coats.

In an aspect, the disclosure provides for a method of increasing crop or plant yield. In yet another aspect, the disclosure provides for a method of increasing plant weight or size relative to an untreated plant.

In an aspect, the disclosure provides for a method of increasing crop or plant yield by applying at least one compound or composition disclosed herein to soil, seed, or plant parts. In another aspect, the disclosure provides for a method of increasing crop or plant yield comprising, consisting of, or consisting essentially of first applying at least one compound or composition described herein to soil or a seed in a first application followed by applying at least one compound or composition described herein in a foliar application. In an aspect, a compound or composition described herein is applied to soil in a first application step, applied to seed in a second application, and to applied to the foliar region of a plant in a third application.

In another aspect, the disclosure provides for a method for reducing nematode damage to a plant comprising, consisting of, or consisting essentially of:

applying a first composition with nematicidal properties to a seed;

applying a second composition with nematicidal properties to soil surrounding the plant produced from the seed; and

applying a third composition comprising a systemic nematicidal compound to an aerial plant part of the plant.

In an aspect, the disclosure provides for a method for reducing nematode damage to a plant comprising, consisting of, or consisting essentially of:

applying a first composition with nematicidal properties to soil;

applying a second composition with nematicidal properties to a seed; and

applying a third composition comprising a nematicidal compound to an aerial plant part of a plant produced from the seed planted in the soil.

In another aspect, the disclosure provides for a method for reducing nematode damage to a plant comprising, consisting of, or consisting essentially of:

applying a compound or composition described herein to an aerial plant part of the plant.

In another aspect, the disclosure provides for a method for reducing nematode damage to a plant comprising, consisting of, or consisting essentially of:

applying a compound or composition described herein to the foliar region of a plant.

In another aspect, the disclosure provides for a method increasing crop yield comprising, consisting of, or consisting essentially of:

applying a first composition with nematicidal properties to a seed;

applying a second composition with nematicidal properties to soil surrounding the plant produced from the seed; and

applying a third composition comprising a systemic nematicidal compound to an aerial plant part of the plant.

In an aspect, the disclosure provides for a method for a method of increasing crop yield comprising, consisting of, or consisting essentially of:

applying a first composition with nematicidal properties to soil;

applying a second composition with nematicidal properties to a seed; and

applying a third composition comprising a nematicidal compound to an aerial plant part of a plant produced from the seed planted in the soil.

In another aspect, the disclosure provides for a method of increasing crop yield comprising, consisting of, or consisting essentially of:

applying a compound or composition described herein to an aerial plant part of the plant.

In another aspect, the disclosure provides for a method of increasing crop yield comprising, consisting of, or consisting essentially of:

applying a compound or composition described herein to the foliar region of a plant.

In an aspect, the nematicidal compound is selected from the group consisting of spirotetramat, oxamyl carbamate, fenamiphos, and compound MON37400.

In another aspect, a compound or composition described herein is applied to the foliar region of a plant or crop from about 1 to about 100 days, about 2 to about 50 days, about 10 to about 50 days, about 15 to about 40 days, about 20 to about 50 days, about 30 to about 50 days, about 40 to about 50 days, about 10 to about 40 days, about 20 to about 40 days, or about 30 to about 40 days after the initial application to soil or seed. In another aspect, a compound or composition described herein is applied to the foliar region of a plant or crop from about 1, about 5, about 10, about 15, about 20, about 25, about 30, about 35, about 40, about 45, about 50, about 75, or about 100 or more days after the initial application to soil or seed. In yet another aspect, a compound or composition described herein is applied to the foliar region of a plant or crop at least 1, at least 5, at least 10, at least 15, at least 20, at least 25, at least 30, at least 35, at least 40, at least 45, at least 50, at least 75, or at least 100 days after the initial application to soil or seed. In another aspect, more than one of the above foliar application times can be used with any of the compositions, compounds, or methods described herein. For example, a compound or composition described herein can be applied in a first foliar application at about 10 days and a second foliar application at about 20 days, a first foliar application at about 20 days and a second foliar application at about 40 days, a first foliar application at about 30 days and a second foliar application at about 50 days, or a first foliar application at about 40 days and a second foliar application at about 50 days.

In another aspect, a compound or composition described herein is applied to the foliar region of a plant or crop at growth stage V2-V3. In another aspect, a compound or composition described herein is applied to the foliar region of a plant or crop at growth stage R1-R2. In yet another aspect, a compound or composition described herein is applied two or more times to the foliar region of a plant or crop: first at growth stage V2-V3 and second at growth stage R1-R2. In another aspect, a compound or composition described herein is applied to the foliar region of a plant or crop at pinhead square timing. In yet another aspect, a compound or composition described herein is applied two or more times to the foliar region of a plant or crop: at least one application at pinhead square and at least one more application after about 10 to about 20 days, after about 15 to about 30 days, after about 10 to about 50 days, after about 20 to about 50 days, or about 10 days, about 20 days, about 30 days, about 40 days, or about 50 days or more.

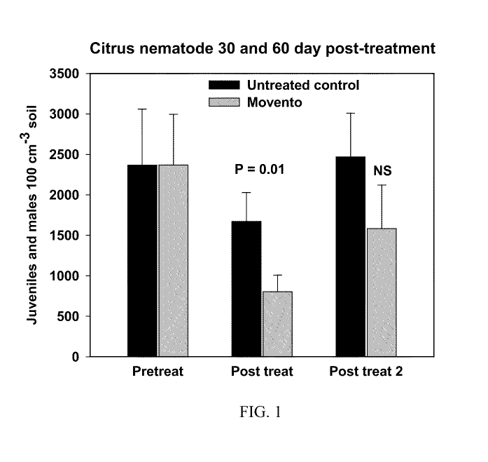

In another aspect, the disclosure provides for a kit comprising, consisting essentially of, or consisting of any of the compounds or compositions disclosed herein. In an aspect, the kit contains one or more, two or more, three or more, four or more, or five or more of the compounds or compositions disclosed herein. In an aspect, the one or more, two or more, three or more, four or more, or five or more compounds or compositions disclosed herein are used in sequential order. In an aspect, the kit includes the combination of compounds and compositions described in Examples 1-11 and FIGS. 1-8. In another aspect, the kit provides for the compounds and compositions described in Examples 1-11 and FIGS. 1-8 applied in a manner that is consistent with the methodology of these examples and figures.

In another aspect, the kit provides that a first compound or composition is used as a seed treatment and a second compound or composition is used in a foliage treatment. In yet another aspect, the kit provides that a first compound or composition is used as a seed treatment, a second compound or composition is used as a seed treatment, and a third compound or composition is used in a foliage treatment. In another aspect, the kit provides that one or more of the compounds or compositions described herein are used as seed or soil treatments and one or more of the compounds or compositions described herein are used in foliage treatments. In another aspect, the kit provides that a plant is first treated with one or more of the compounds or compositions described herein in a soil, seed, or combination soil and seed treatment and second that a plant is treated with one or more of the compounds or compositions described herein in a foliage treatment.

In another aspect, the kit provides that a first compound or composition is used as a soil treatment and a second compound or composition is used in a foliage treatment. In yet another aspect, the kit provides that a first compound or composition is used as a soil treatment, a second compound or composition is used as a soil treatment, and a third compound or composition is used in a foliage treatment. In another aspect, the kit provides that a first compound or composition is used as a soil treatment and a second compound or composition is used in a seed treatment. In yet another aspect, the kit provides that a first compound or composition is used as a soil treatment, a second compound or composition is used as a seed treatment, and a third compound or composition is used in a foliage treatment.

In another aspect, the kit provides that a first compound or composition described herein is used in a soil, seed, or combination soil/seed treatment and a second compound or composition described herein is used in a foliage treatment from about 1 to about 100 days, about 2 to about 50 days, about 10 to about 50 days, about 15 to about 40 days, about 20 to about 50 days, about 30 to about 50 days, about 40 to about 50 days, about 10 to about 40 days, about 20 to about 40 days, or about 30 to about 40 days after the initial application to soil or seed. In another aspect, the kit provides that the foliage treatment compound or composition described herein is applied to the foliar region of a plant or crop at pinhead square, growth stage V2-V3, growth stage R1-R2, or first at growth stage V2-V3 and second at growth stage R1-R2. In another aspect, the kit specifies the amount of compound or composition to be applied to a crop or plant (for example, in pounds/acre or other identifying range).

In an aspect, the kit includes instructions describing the methodology described herein. In another aspect, the kit includes instructions describing the methodology set forth in Examples 1-11 and FIGS. 1-8. In an aspect, the instructions are included with the kit, separate from the kit, in the kit, or are included on the kit packaging.

The following examples serve to illustrate certain aspects of the disclosure and are not necessarily intended to limit the disclosure.

### EXAMPLES

### Example 1

Example 1 shows the crop yield results under nematode pressure for the combination of spore-forming bacterium and insect control agent applied to genetically modified seed (control+spore forming bacterium) compared to genetically modified seed with just an insect control agent (control).

The genetically modified seeds in this comparison experiment were sourced from DELTA and PINE LAND available from MONSANTO, which are cotton seeds that contain both glyphosate tolerance (ROUND-UP READY trait) and insect tolerance (Bt gene) gene expressions. The insecticide was imidacloprid (GAUCHO GRANDE) or imidacloprid and thiodicarb (AERIS). The spore-forming bacterium was B. firmus. The nematode type varied from none, root knot nematode, reiniform nematode, and lance nematode. The concentration of insect control agents was 600 gm ai/L, and in liquid form. The application rate of the insect control agents was 500 to 1000 gm ai/100 kg. The concentration of B. firmus ranged from 100,000 to 10,000,000 colony forming units per seed. The insect control agent and B. firmus were mixed together in an aqueous suspension in enough volume to adequately cover the cottonseed. The rate of the mixture varied from 1369 to 2608 mL per 100 kg of seed to assure adequate coverage of the various seed sizes. Once planted, the cotton seed grew to full maturity and the results measured in pounds of cotton per acre.

Table 1 compares the pounds of cotton per acre between the control and the control plus spore forming bacterium at various nematode types. The yield difference numbers represent an average of several experimental results, unless otherwise indicated.

TABLE 1

| Exp. No. | Nematode | Control | Control + B. firmus | Yield difference |
|---|---|---|---|---|
| 1 | Lance | 2957 | 3206 | 249 |
| 2 | Reniform | 2044 | 2132 | 88 |
| 3 | Root Knot | 2183 | 2111 | −72 |
| 4 | Root Knot | 3226 | 3298 | 72 |
| 5 | Root Knot | 3064 | 3254 | 190 |
| 6 | Root Knot | 337 | 300 | −37 |
| 7 | Root Knot | 1530 | 1643 | 113 |
| 8 | Reniform | 1165 | 1165 | 0 |
| 9 | None | 2280 | 2250 | −30 |
| 10 | None | 2108 | 2230 | 122 |
| 11 | Reniform | 2645 | 2721 | 76 |
| 12 | Root Knot | 1884 | 1799 | −85 |
| 13 | None | 3007 | 3246 | 239 |
| 14 | Root Knot | 1615 | 1602 | −13 |

Some of the negative yield values are the result of uncontrollable environmental and planting issues. Regarding Experiment Number 3, the negative value may be attributable to low planting numbers from planter error, which will effect overall crop yield. For Experiment No. 6, no replicates were done because of damage to the planting plots.

### Example 2

Example 2 shows the crop yield results under nematode pressure for the combination of spore-forming bacterium and insect control agent applied to genetically modified seed (control+spore forming bacterium) compared to genetically modified seed with just an insect control agent (control). The genetically modified seed in this comparison experiment were sourced from STONEVILLE available from Bayer CropScience, which are cotton seeds that contain both glyphosate tolerance (ROUND-UP READY trait) and insect tolerance (Bt gene) gene expressions. The insecticide was imidacloprid (GAUCHO GRANDE) or imidacloprid and thiodicarb (AERIS). The spore-forming bacterium was B. firmus. The nematode type varied from none, root knot nematode and reniform nematode. The concentration of insect control agents was 600 gm ai/L, and in liquid form. The application rate of the insect control agents was 500 to 1000 gm ai/100 kg. The concentration of B. firmus ranged from 100,000 to 10,000,000 colony forming units per seed. The insect control agent and B. firmus were mixed together in an aqueous suspension in enough volume to adequately cover the cottonseed. The rate of the mixture varied from 1369 to 2608 mL per 100 kg of seed to assure adequate coverage of the various seed sizes. Once planted, the cotton seed grew to full maturity and the results measured in pounds of cotton per acre.

Table 2 compares the pounds of cotton per acre between the control and the control plus spore forming bacterium at various nematode types. The yield difference numbers represent an average of several experimental results, unless otherwise indicated.

TABLE 2

| Exp. No. | Nematode | Control | Control + B. firmus | Yield difference |
|---|---|---|---|---|
| 1 | Root Knot | 1658 | 1728 | 70 |
| 2 | Root Knot | 2780 | 2766 | −14 |
| 3 | Reniform | 404 | 377 | −27 |
| 4 | None | 596 | 632 | 36 |

### Example 3

Example 3 shows the results of Movento (spirotetramat) applied as a foliar spray treatment to potted tomato plants for reducing infestation by Columbia root-knot nematode (Meloidogyne chitwoodi) in a greenhouse environment.

Soil contained within the pots were infested with nematodes prior to planting and two foliar spray applications were made on 7-day intervals for 8 weeks. Each foliar spray application contained the equivalent of 88 grams active ingredient/hectare, applied as a curative treatment and diluted in sufficient carrier volume to allow for complete coverage to the point where runoff of the spray solution occurred. A soil application of Temik (aldicarb) was used as the commercial standard for comparison using equivalent per acre use rates. Each pot was destructively sampled at 8 weeks following the last application and populations of juvenile nematodes were determined within 500 cc of soil and 1 gram of dry root tissue. In addition, both root fresh and dry weights were recorded.

Table 3 contains the results of evaluations made 8 weeks following the last application, clearly showing substantial reductions in nematode populations in both soil and roots from the spirotetramat foliar treatment; no effect was observed on either root fresh or dry weights.

TABLE 3

| | Juveniles/ | Juveniles/ | | |
|---|---|---|---|---|
| | 500 cc | 1 gram | Root Fresh | Root Dry |
| Treatment | Soil | dry root tissue | Weight, grams | Weight, grams |
| Untreated | 556 | 4450 | 20.7 | 3.0 |
| Movento | 4 | 246 | 18.6 | 2.6 |
| Temik | 196 | 910 | 11.6 | 1.7 |

### Example 4

### Foliar Application of Movento to Citrus in Pots for Control of Tylenchulus semipenetrans

Treatments: 15 trees sprayed with Movento, 15 trees sprayed with water (presample each pot); 25 mL/tree

Protocol: T. semipenetrans larvae was added to all pots. The following day trees were removed from the greenhouse. The top of each pot was covered to exclude spray from soil. Movento (SC 240) was sprayed in a concentration of 2.6 mL plus 2.5 mL adjuvant MSO (methylated seed oil), (100% active w/v, added to the spray solution at 0.25% v/v) per liter spray solution. The canopy was sprayed from two sides of trees to runoff with a 2 gallon “Sure Spray” pump sprayer (Chapin Mfg.) using a nozzle that delivered a cone shape spray pattern. The material was allowed to dry before returning plants to greenhouse. The process was repeated in 14 days.

For this citrus nematode trial, 5-year old Volkamer lemon seedlings were infested with T. semipenetrans obtained from the field and maintained in the greenhouse (25 to 32° C.) for use in pesticide trials. Trees used in the experiment were not treated with nematicidal compounds. The seedlings were growing in a 50:50 mixture of Astatula sand (97% sand) and Pro-mix potting mixture in rectangular pots (10×10×30 cm). Trees were irrigated normally, but received no fertilizer or pesticide treatments other than Movento during the experiment. Effects on citrus nematode were evaluated by soil sampling 30 days and 60 days after treatment.

As can be seen in FIG. 1, the number of nematodes is reduced in the treated sample as measured after 30 days compared to control. Sixty days post-treatment might require one or more additional treatments with a foliar applied nematicide.

### Example 5

Example 5 shows the reduction in damage from root lesion nematode (Pratylenchus vulnus) on mature 25-year walnut trees.

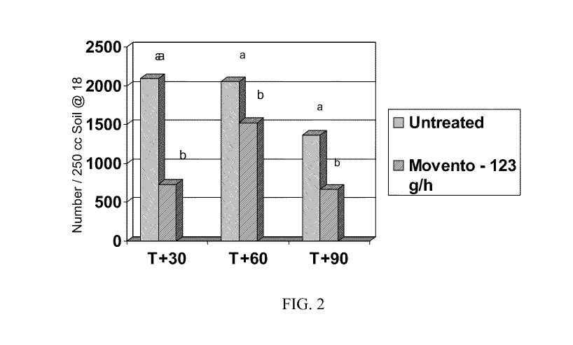

In this example, a foliar spray treatment of Movento (spirotetramat) at 0.11 lbs. active ingredient per acre was applied using a commercial airblast sprayer delivering 300 gallons of water per acre. Evaluations of the effectiveness of the treatment were made at 30, 60, and 90 days following treatment by counting the number of live nematodes per 250 cc of soil surrounding the root system at 18 inches below the soil surface. Treatment means were subjected to statistical analysis of variance (P=0.05) and significant reductions in nematode populations between the untreated and Movento treatment was observed at all evaluation dates following the foliar treatment as shown in FIG. 2.

### Example 6

A foliar treatment composition comprising spirotetramat and imidacloprid was tested on soybean in a potted greenhouse environment. Treatments were initiated when sufficient foliage existed for uptake of spirotetramat. Three foliar treatments were applied on a 7-day interval using sufficient carrier volume to ensure good coverage Ammonium sulfate was included to facilitate good uptake into the plant.

ASSESSMENT: 10 plants per treatment, as well as surrounding soil, was removed from the pots and separated into above and below ground portions. Both shoots and roots were weighed and the number of nematode cysts and eggs were recorded.

There appears to be a linear response for reducing the number of nematode cysts per gram of root weight. There is also a reduction of eggs per gram of root. Both of these responses appear to be in a linear range.

TABLE 4

| | Dosage, | | | |
|---|---|---|---|---|
| | grams active | Weight of | Nematode | Nematode |
| | ingredient per | Root, | Cysts/ | Eggs/ |
| Treatment | hectare | grams | Gram Root | Gram Root |
| Untreated | N/A | 2.2 | 309 | 27544 |
| IMD + SPT | 52.3 | 2.3 | 263 | 31310 |
| IMD + SPT | 78.4 | 2.6 | 264 | 26600 |
| IMD + SPT | 105 | 2.5 | 193 | 18200 |

IMD = imidacloprid
SPT = spirotetramat; each is added in 1:1 ratio; all treatments except untreated included Ammonium Sulfate

### Example 7

A soil treatment composition of ADMIRE Pro (imidacloprid) and B. firmus was applied to potted tomato at planting for control of southern root-knot nematode in a greenhouse environment; another set of potted tomatoes incorporated this same treatment followed by sequential foliar spray treatments of Movento (spirotetramat). Two foliar applications were made at the equivalent of 0.078 lbs. active ingredient per acre, using a 40 gallon per acre spray volume equivalent, sufficient to allow complete coverage of the foliage to the point of runoff. Effects of the treatments on the severity of root damage (galling) from southern root-knot nematode (Meloidogyne incognita) is evaluated on a 0 to 5 rating scale, where 0=healthy roots with no galls from nematode infestation and 5=severely damaged roots.

As shown in Table 5, the addition of B. firmus to the soil provided a moderate level of reduction of nematode damage. A similar moderate level of reduction of nematode damage was observed when only Movento was applied as a foliar treatment. However, when the two products used in combination the level of reduction of nematode damage was higher than either product applied alone.

TABLE 5

| | | Root Gall |
|---|---|---|
| Treatment | Application Method | Severity Index |
| ADMIRE Pro | Soil Treatment | 4.6 |
| ADMIRE Pro + B. firmus | Soil Treatment | 3.8 |
| ADMIRE Pro + Movento | Soil/Foliar Treatment | 3.0 |
| ADMIRE Pro + B. firmus + | Soil/Foliar Treatment | 2.7 |
| Movento | | |

### Example 8

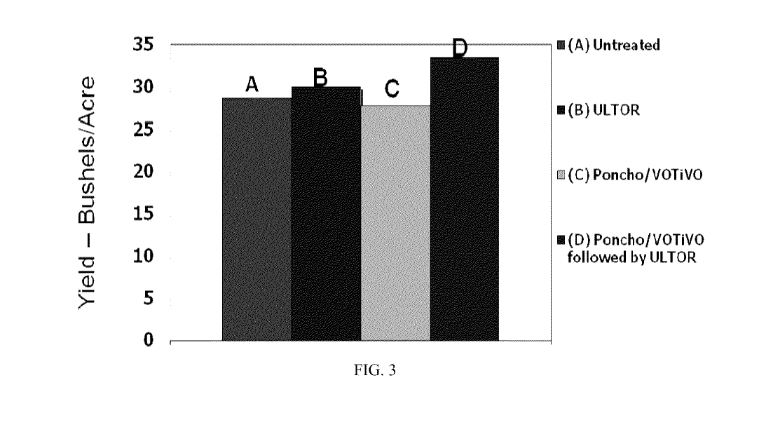

FIG. 3 shows that yield (bushels per acre) of soybean infested with Soybean Cyst Nematode is increased in soybean treated with Poncho/VOTiVO in a seed application followed by foliage treatment with ULTOR relative to an untreated sample. As set forth in FIG. 3, an untreated sample (A) is compared with soybean foliage treated with 4.8 fluid ounces of ULTOR (B), soybean seed treated with 0.047 pounds/acre of Poncho/VOTiVO (C), and soybean seed treated with 0.047 pounds/acre of Poncho/VOTiVO followed by foliage treatment with ULTOR. Methylated seed oil (0.5% v/v) and Ammonium Sulfate (2 pounds/acre) are added to the ULTOR treatment. The foliar treatment is applied at both growth stages (1) V2-V3 and (2) R1-R2.

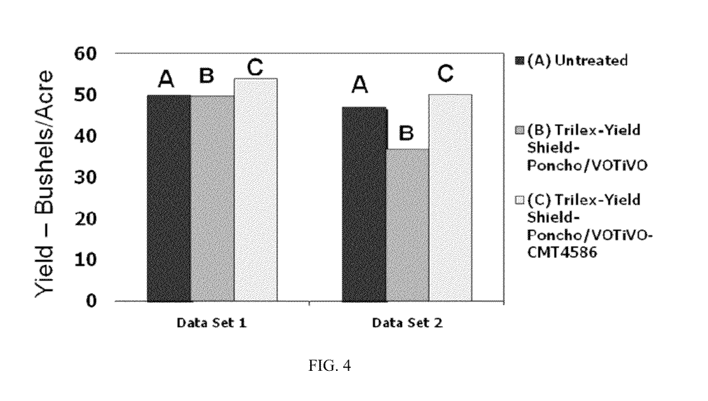

FIG. 4 shows that yield (bushels per acre) of soybean infested with Soybean Cyst Nematode is increased in soybean treated with Trilex-Yield Shield in a seed application and of Poncho/VOTiVO in a seed application as well as CMT 4586 in a foliar application relative to an untreated sample. As set forth in FIG. 4, an untreated sample (A) is compared with soybean seed treated with a combination of 0.047 pounds/acre of Trilex-Yield Shield and 0.047 pounds/acre of Poncho/VOTiVO (B), and soybean seed treated with a combination of 0.047 pounds/acre of Trilex-Yield Shield and 0.047 pounds/acre of Poncho/VOTiVO followed by a foliage treatments of 0.047 pounds/acre of CMT 4586 (C). Methylated seed oil (0.25% v/v) is applied in combination with the CMT 4586 treatment. The foliar CMT 4586 treatment is applied at (1) V2-V3 and (2) R1-R2. As described in FIG. 4, CMT 4586 represents a 1:1 mixture of imidacloprid and spirotetramat.

### Example 9

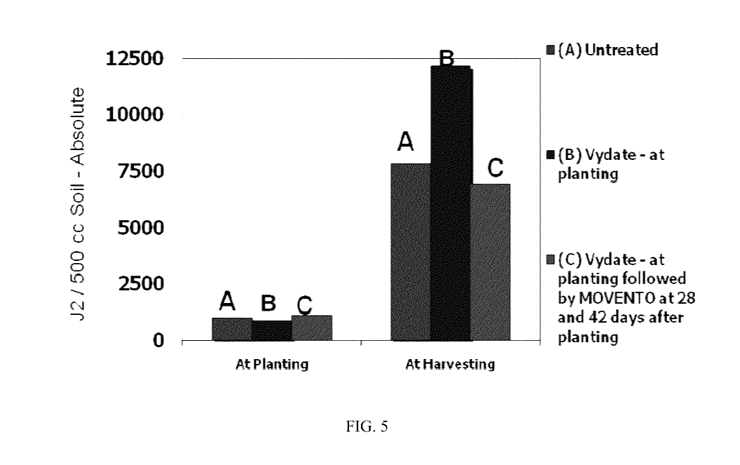

FIG. 5 shows the reduction of juvenile Southern Root-knot nematodes in 500 cc of soil at the time of harvesting for tomato treated with Vydate in a soil application at planting followed by Movento in a foliar treatment relative to an untreated sample. As set forth in FIG. 5, an untreated sample (A) is compared with a soil application of a sample treated with 48 ounces/acres of Vydate at planting (B), and a soil application of a sample treated with 48 ounces/acres of Vydate at planting followed by foliage treatments of 0.078 pounds/acre of Movento (C). Dyne-Amic (0.25% v/v) is applied in combination with the Movento foliar treatment. The foliar Movento treatment is applied at 28 and 42 days after planting.

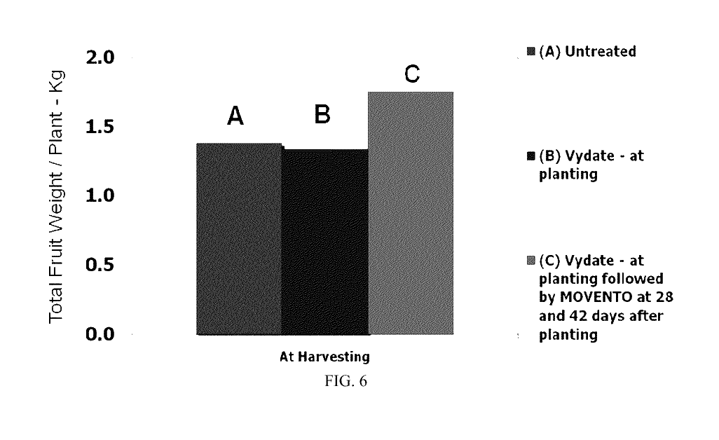

FIG. 6 shows the yield (total fruit weight per plant in Kg) of tomato infested with Southern Root-knot nematode treated with a soil application of Vydate at planting followed by foliage treatments of Movento relative to an untreated tomato. As set forth in FIG. 6, an untreated sample (A) is compared with a sample treated with a soil application of 48 ounces/acres of Vydate at planting (B), and a soil application of a sample treated with 48 ounces/acres of Vydate at planting followed by foliage treatments of 0.078 pounds/acre of Movento (C). Dyne-Amic (0.25% v/v) is applied in combination with the foliage treatments of Movento. The foliar Movento treatment is applied at 28 and 42 days after planting.

### Example 10

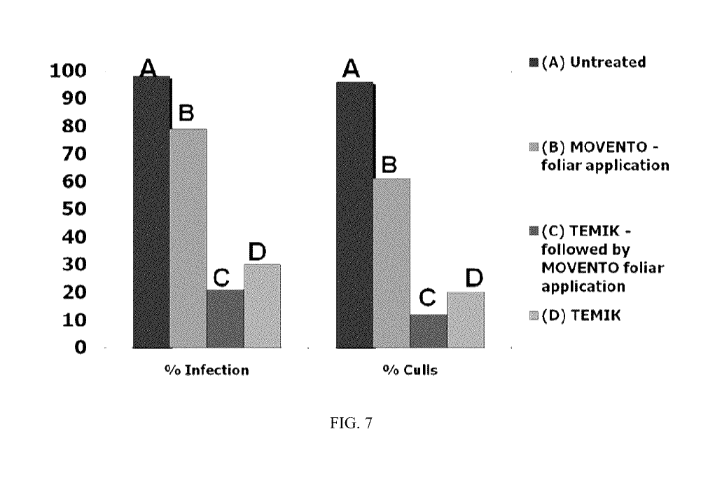

FIG. 7 shows the percent of infection and culls in potato infested with Columbia Root-knot nematode. As set forth in FIG. 7, an untreated sample (A) is compared with a sample treated with potato foliage of 0.078 pounds/acre of Movento (B), a potato treated with soil treatment of 20 pounds/acre of Temik followed by foliage treatments with 0.078 pounds/acre of Movento (C), and potato treated with a soil treatment of 20 pounds/acre of Temik (D). Dyne-Amic (0.25% v/v) is applied in combination with the foliage treatment of Movento. The foliage treatment of Movento is applied at 42 and 56 days after planting. In FIG. 7, the percent of infection and culls in Potato infested with Columbia Root-knot nematode is determined by using the USDA-1 grading system. As described in FIG. 7, treatment with a soil application of Temik followed by foliage treatments with Movento reduces the percent infection and culls relative to an untreated sample or treatment by soil or foliar applications alone.

### Example 11

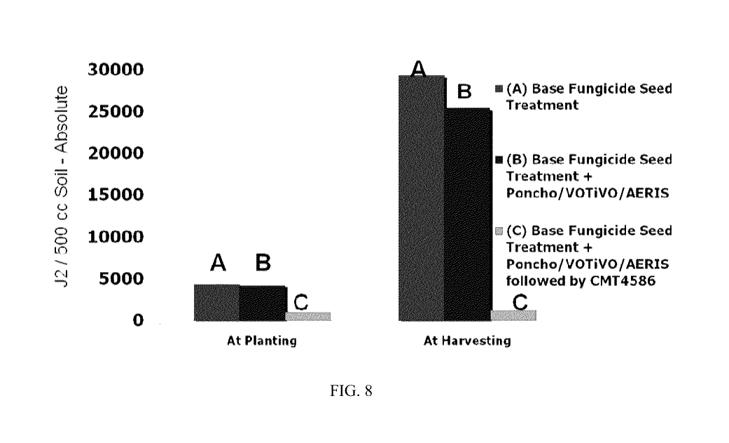

FIG. 8 shows the population of juvenile Reniform nematodes in 500 cc of soil at the time of planting and at the time of harvest in cotton. As described in FIG. 8, a base fungicidal seed treatment (A) is compared with cotton seed treated with a base fungicide seed treatment and 0.047 pounds/acre of Poncho/VOTiVO/Aeris (B), and cotton seed treated with a base fungicide seed treatment and 0.047 pounds/acre of Poncho/VOTiVO/Aeris followed by foliage treatments of 0.062 pounds/acre of CMT 4586 (C). In FIG. 8, CMT 4586 was applied with pinhead squared timing as well as at 21 days after planting. As described in FIG. 8, CMT 4586 represents a 1:1 mixture of imidacloprid and spirotetramat. As set forth in FIG. 7, treatment with a base fungicide seed treatment, a Poncho/VOTiVO/Aeris seed application, followed by treatment of CMT 4586 in a foliar application reduces the population of juvenile Reniform nematodes in 500 cc of soil at the time of harvest in cotton relative to an untreated sample.

What is claimed is:

1. A method for reducing nematode damage to a plant comprising:
applying a first composition with nematicidal properties to a seed; and
applying a second composition comprising a systemic nematicidal compound to an aerial plant part of a plant produced from the seed.

2. The method of claim 1, wherein the first composition is the same as the second composition.

3. The method of claim 1, wherein the first composition comprises a chemical nematicide.

4. The method of claim 3, wherein the chemical nematicide is selected from the group consisting of acetoprole, benclothiaz, chloropicrin, dazomet, DBCP, DCIP, 1,2-dichloropropane, 1,3-dichloropropene, furfural, iodomethane, metam, methyl bromide, methyl isothiocyanate, and xylenols, antibiotic nematicides, carbamate nematicides, oxime carbamate nematicides, and organophosphorous nematicides.

5. The method of claim 1, wherein the first composition comprises a biological nematicide.

6. The method of claim 5, wherein the biological nematicide is selected from the group consisting of Myrothecium verrucaria, Burholderia cepacia, Bacillus chitonosporus, Paecilomyces lilacinus, Bacillus amyloliquefaciens, Bacillus firmus, Bacillus subtilis, and Bacillus pumulis.

7. The method of claim 1, wherein the systemic nematicidal compound is selected from the group consisting of spirotetramat, oxamyl carbamate, fenamiphos, and compound MON37400.

8. The method of claim 1, wherein the first composition, or the second composition, or both the first composition and the second composition, further comprises at least one insecticide.

9. The method of claim 1, wherein the first composition, or the second composition, or both the first composition and the second composition, further comprises at least one fungicide.

10. The method of claim 1, wherein the first composition, or the second composition, or both the first composition and the second composition, further comprises at least one herbicide.

11. A method for reducing nematode damage to a plant comprising:
applying a first composition with nematicidal properties to soil surrounding the plant; and
applying a second composition comprising a systemic nematicidal compound to an aerial plant part of the plant.

12. The method of claim 11, wherein the first composition is the same as the second composition.

13. The method of claim 11, wherein the first composition comprises a chemical nematicide.

14. The method of claim 13, wherein the chemical nematicide is selected from the group consisting of acetoprole, benclothiaz, chloropicrin, dazomet, DBCP, DCIP, 1,2-dichloropropane, 1,3-dichloropropene, furfural, iodomethane, metam, methyl bromide, methyl isothiocyanate, and xylenols, antibiotic nematicides, carbamate nematicides, oxime carbamate nematicides, and organophosphorous nematicides.

15. The method of claim 11, wherein the first composition comprises a biological nematicide.

16. The method of claim 15, wherein the biological nematicide is selected from the group consisting of Myrothecium verrucaria, Burholderia cepacia, Bacillus chitonosporus, Paecilomyces lilacinus, Bacillus amyloliquefaciens, Bacillus firmus, Bacillus subtilis, and Bacillus pumulis.

17. The method of claim 11, wherein the systemic nematicidal compound is selected from the group consisting of spirotetramat, oxamyl carbamate, fenamiphos, and compound MON37400.

18. A method for reducing nematode damage to a plant comprising:
applying a first composition with nematicidal properties to a seed;
applying a second composition with nematicidal properties to soil surrounding the plant produced from the seed; and
applying a third composition comprising a systemic nematicidal compound to an aerial plant part of the plant.

19. A method for reducing nematode damage to a plant comprising:
applying a first composition with nematicidal properties to soil;
applying a second composition with nematicidal properties to a seed; and
applying a third composition comprising a systemic nematicidal compound to an aerial plant part of a plant produced from the seed planted in the soil.

20. A method for reducing nematode damage to a plant according to claim 1, wherein the second composition is applied to an aerial plant part of a plant at least one day after application of a first composition to a seed.
